(19) United States
(12) Patent Application Publication
(10) Pub. No.: US 2007/0210527 A1
(43) Pub. Date: Sep. 13, 2007

(54) Seal device

(76) Inventor: Yoshio Yano, Kitakyushu (JP)

Correspondence Address: HODGSON RUSS LLP;THE GUARANTY BUILDING, 140 PEARL STREET, SUITE 100, BUFFALO, NY, 14202-4040, US

(21) Appl. No.: 11/366,471

(22) Filed: Mar. 1, 2006

(51) Int. Cl. F16J 15/34

(52) U.S. Cl. 277/398

(57) ABSTRACT

A shaft seal, for use with a rotating shaft and a structure defining an aperture through which the shaft extends, is disclosed. The seal comprises a rotor, a seal member and a driver. The rotor, in use, is sealingly secured to said shaft, on one side of said aperture, for rotation therewith. The seal member, in use, defines a void through which said shaft extends in spaced relation, is operatively sealed about said aperture and is manipulable between a first position, abutting the rotor to seal the aperture, and a second position, spaced from the rotor. The driver is adapted to oscillate the seal member between the first position and the second position, at a high frequency such that, in use, liquid disposed on said one side of said aperture cannot infiltrate said void for egress to said aperture.

### FIELD OF THE INVENTION

The present invention relates to the field of dynamic (ultra sonic) shaft seals.

### BACKGROUND OF THE INVENTION

Dynamic shaft seals are well-known. For example, such seals are often used in association with liquid pumps, to enable a shaft to carry power from an external motor into the interior of the pump to drive an impeller or the like. The dynamic shaft seal is utilized to minimize egress of the liquid from the pump interior. Common conventional shaft seals consist of a construction having the rotary side (shaft) and the stationary side (bearing) urged against one another under the force of a spring or the like to form a seal. With this construction, rubbing between the surfaces results in friction, causing heat generation, wear deformation and power losses. As a result of, inter alia, this deformation and wear, a gap exists between the surfaces, and as it is not possible to definitively fill this gap under spring force, leakage will occur. Moreover, in the event that the transported liquid is at an elevated temperature, under high pressure or corrosive, preventing leakage becomes yet more difficult. Another type of seal is the so-called magnetic fluid seal, wherein a magnetic fluid is injected into the seal gap such that the surfaces do not rub directly. These seals have a problem associated with the evaporation of the magnetic fluid. Recently, so-called gas seals have been developed, that deliver ultra-high pressure air or gas into the seal gap, providing for separation between the surfaces, but due to the complexity and precision of these seals, they are not in widespread use.

### SUMMARY OF THE INVENTION

A shaft seal, for use with a rotating shaft and a structure defining an aperture through which the shaft extends, forms one aspect of the invention. This shaft seal comprises a rotor, a seal member and a driver. The rotor, in use, is sealingly secured to said shaft, on one side of said aperture, for rotation therewith. The seal member, in use, defines a void through which said shaft extends in spaced relation, is operatively sealed about said aperture and is manipulable between a first position, abutting the rotor to seal the aperture, and a second position, spaced from the rotor. The driver is adapted to oscillate the seal member between the first position and the second position, at a frequency such that, in use, liquid disposed on said one side of said aperture cannot infiltrate said void for egress to said aperture.

A shaft seal, for use with a rotating shaft and a structure defining an aperture through which the shaft extends, forms another aspect of the invention. This shaft seal comprises a rotor, an oscillating body and a coil. The rotor, in use, is sealingly secured to said shaft for rotation therewith. The oscillating body, in use, is disposed between said rotor and said aperture, defines a void through which said shaft extends in spaced relation, is operatively sealed about said aperture and includes a magnetostrictive portion deformable such that the oscillating body is configurable in a first configuration, abutting the rotor to seal the aperture, and a second configuration, spaced from the rotor. The coil surrounds the magnetostrictive portion and is adapted to cause oscillatory deformation of the oscillating body to cause same to oscillate between the first configuration and the second configuration.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter being briefly described hereinbelow.

### BRIEF DESCRIPTION OF THE DRAWINGS

FIG. 1 is a cross-sectional diagram of a test device containing the shaft seal;

FIG. 2 is a A-A direction cross-sectional diagram of FIG. 1;

FIG. 3 is an X1-Y1 direction cross-sectional diagram of FIG. 1;

FIG. 4 is an X2-Y2 direction cross-sectional diagram of FIG. 1;

FIG. 5 is a cross-sectional diagram of the rotor and the seal member;

FIG. 6 is an X3-Y3 direction cross-sectional diagram of FIG. 5; and

FIG. 7 is an X4-Y4 direction cross-sectional diagram of FIG. 6.

### DETAILED DESCRIPTION

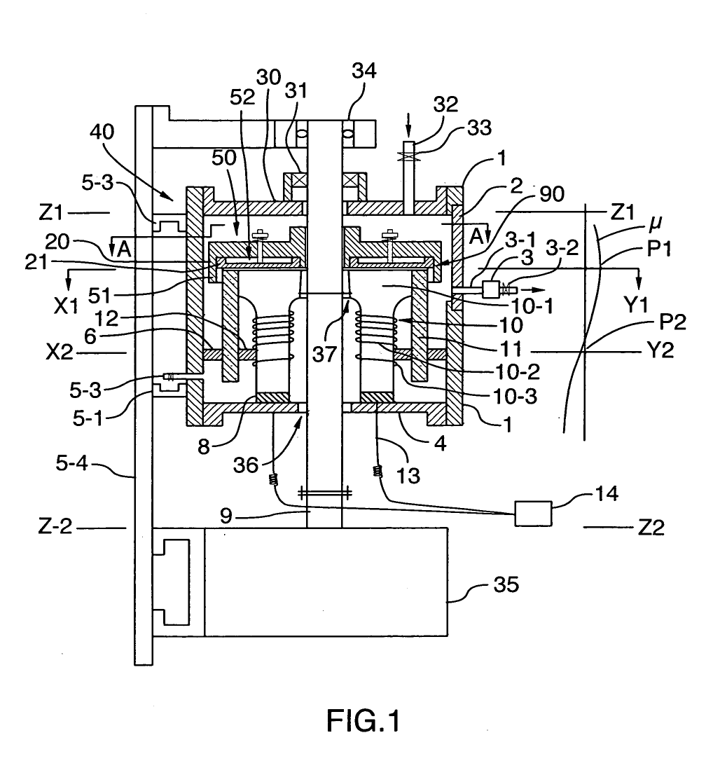

A shaft seal constructed according to a presently preferred embodiment of the present invention is illustrated in cross-section in FIG. 1, in use, and designated with general reference numeral 40. More particularly, in FIG. 1, within lines Z1 and Z2, the shaft seal 40 is shown in use with a rotating shaft (9) and a structure or support plate (4) defining an aperture (36) through which the shaft (9) extends. On both sides of lines Z1 and Z2 is test equipment including a seal 31, an inlet 32, an open-close valve 33, a bearing 34 and a drive motor 35. For greater certainty, it should be understood that the rotating shaft (9), the structure (4) and the test equipment do not form part of the invention.

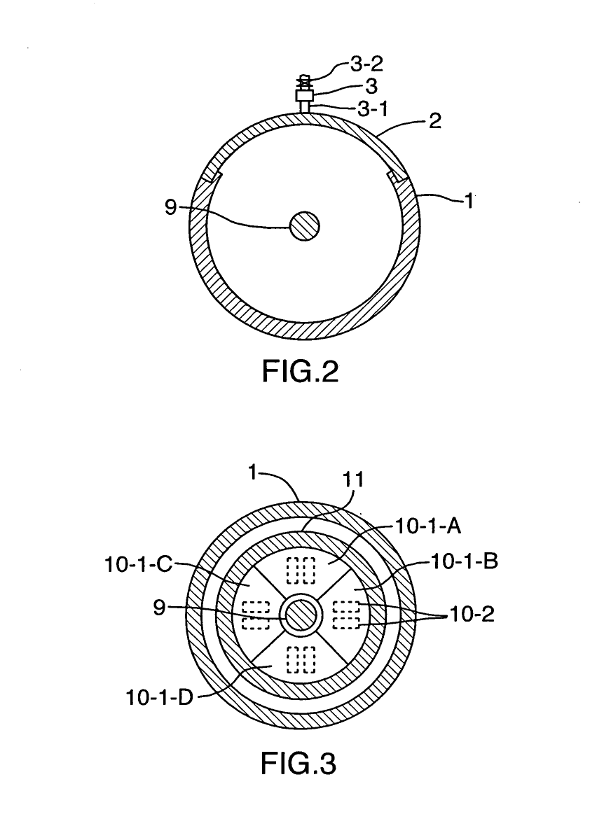

Regarding the mounting location of the shaft seal, the left side of FIG. 1 can be the bottom thereof, and the right side can be the top. The shaft seal is a seal device with the stationary side being an oscillator made of a series of magnetostrictive oscillators (10) joined together within a steel main tube (1). Opposite this structure is a rotor 50 including a seal disc (20) which is attached to the rotary shaft (9). The main tube (1) has an inspection cover (2), to which are attached an air bubble side tube (3-1), an air bubble collector (3) and an open-close valve (3-2). The inspection cover (2) permits inspection and adjustment of the seal, as hereinafter discussed. FIG. 2 is a cross-sectional diagram of this part of the main tube (1) taken along lines A-A of FIG. 1. If the Z1 side of the main tube touches the load side, then even if the Z2 side is open, there is no interference. The main tube is attached to a base (54) by support structures (5-1,5-2) and has attached thereto a drainage valve (5-3).

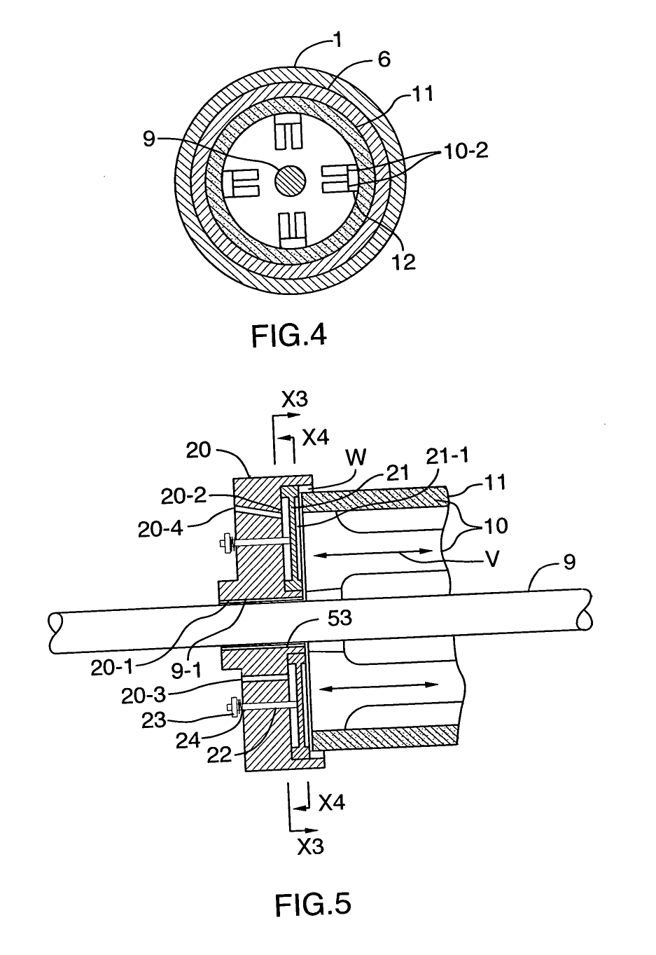

The magnetostriction type oscillators (10) (or oscillating bodies) each comprise an end portion (10-1-A(-D)) and a pair of legs or magnetostrictive portions (10-2), all joined together. The legs (10-2) are formed of magnetostrictive material, in this case, ferrite. The end portions (10-1-A(-D)) are securely joined together by silver solder to form a seal member (10-1). The seal member (10-1) defines a planar, circular surface. The external surface of each end portion (10-1-A(-D)) is joined to a cylinder (11) of the same material (ferrite), creating a unitary oscillating body. The details of this are shown in FIGS. 3,4. FIG. 3 is an X1-Y1 direction plane diagram of FIG. 1. Through the center of this oscillating body, a void 37 is defined for the rotary shaft to pass through (9) in spaced relation. FIG. 4 is an X2-Y2 cross-sectional diagram of FIG. 1. At the node (P2) of the oscillating body's amplitude of vibration (μ), an annular support leg (12) is inserted between the cylinder (11) and the legs (10-2), and joined to each. The support leg (12) material is the same as that of the cylinder (11). Also, a ring (6) is attached between the main tube (1) and the cylinder (11), fixing the oscillating body to the main tube (1). Furthermore, sponge rubber pads (8) are positioned between the oscillator legs (10-2) end and the support plate (4) which is attached to the main tube (1). Wrapped around each pair of legs (10-2) is an excitation coil (10-3), each coil (10-3) being connected to a dispatch device (14), and all excited simultaneously. The excitation coils (10-3), dispatch device (14) and the legs (10-2) together form a driver. Since the excitation coils may become wet, for example, in the event of power failure to the driver, sheathed lines (13) are used to connect the coils (10-3) to the dispatch device (14).

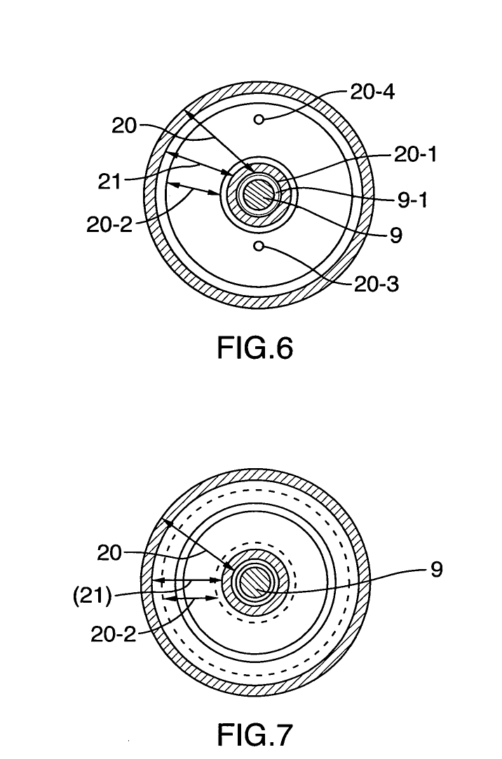

FIG. 5 is a cross sectional diagram showing the construction of rotor (50). The seal disc (20) is attached to the rotary shaft (9). The connection of seal disc (20) and rotary shaft (9) is achieved by screwing together the thread (9-1) around the circumference of the shaft and the thread (20-1) on the inner surface of the seal disc (20). This allows the disc (20) to be able to slightly shift laterally along the shaft (9) and allows the degree of contact of the seal disc (20) and the oscillator end portion circular planar surface to be adjusted. Attached to the contact surface of the seal disc, in a hollow (52) formed therein, is an annular ring disc (21) (hereafter referred to as the interaction disc). Attached to the inner surface of the interaction disc is a rim (53), creating a gap (20-2) between it and the seal disc (20). Leading to this gap are small holes or passages (20-3,20-4) that allow external liquid flowing through the holes and gap to cool the interaction disc. The degree of contact between the interaction disc and the oscillator is adjustable by means of a series of bolts (22) welded into the inner surface of the interaction disc, and nuts (23) and springs (24) attached to the outside of the seal disc on secured on the bolts. The rods or shafts of the bolts (22) have some flexibility, such that the connection between the interaction disc and seal disc is not rigid. The play in this non-rigid connection can be adjusted by manipulating the nuts (23). Furthermore, on the interaction disc surface, an elasticity disc (21-1) or layer of vulcanized rubber is affixed. FIG. 6 is an X3-Y3 direction cross-sectional diagram of FIG. 5. FIG. 7 is an X4-Y4 direction cross-sectional diagram of FIG. 5. An annular flange 51 extends from the seal disc, to surround, in close-fitting, spaced relation, the end of cylinder (11).

In operation, the driver causes oscillatory deformation of the oscillating body to cause the circular planar surface of seal member (10-1) to oscillate in direction V (locate V) at a very high frequency, about 10 kHz or higher, between a first position or configuration (not shown), abutting the elasticity disc of the rotor to seal the aperture, and a second position or configuration, shown in FIG. 1, spaced from the rotor. The distance of movement of the interaction disc within one oscillation, that is, between the first position and second position, is less than 1/100 mm. P1 shows the location of peak amplitude. This action serves to cause the oscillating body to contact the elasticity disc (21-1) via high frequency oscillation, such that liquid introduced via inlet 32 into contact with rotor cannot infiltrate along direction W (locate W) between the oscillating body and elasticity disc, to enter the void 37 and thereby travel to the aperture 36. In order to adjust the contact pressure, the seal disc and the rotating shaft are screwed together. Adjustment of the oscillating body and the interaction disc is effected by the sprung bolts. The sponge rubber inserts (8) prevent the vibrations of the oscillating body from propagating to its surroundings.

Operational Example

For test purposes, a device as in FIG. 1, with Z1 at the top side and Z2 at the bottom side, was constructed. The dispatch device (14) provided 100 W output power, with power and amplitude adjusted to provide amplitude of 0-5 micrometers and a frequency of 20 kHz. Tap water (4 kg/cm² pressure) was connected to inlet 32, and the shaft was rotated at 3420 rpm During weekly continuous operation, with a daily check on all seal components, over a period of five weeks, the results were: absolutely no leakage, wear, deformation or cavitation damage in the seal over the five weeks. Inspection following the testing revealed virtually no scratches due to wear or deformation due to heat generation.

Without intending to be bound by theory, within the seal gap of a mechanical seal, there is believed to be an extremely thin continuous liquid membrane. It is thought that this liquid membrane itself forms the seal. During operation, an irregular radial oscillation forms in both the rotary and stationary side. As a result, there is a change in the thickness of the membrane. In other words, there is a repeated suction and squeezing out of liquid towards the seal face, i.e., a pumping action. Since liquid is not compressible, when compression is applied, a powerful squeezing force is applied, and it is squeezed out to the perimeter. This squeezed-out liquid becomes one of the sources of leakage. Also, the scars due to wear and deformation due to heating act as pathways for the liquid, which also serves as another major source for leakage. It is believed that in the present invention, the high frequency oscillation causes a cavitation air bubble within the liquid membrane in the seal gap (g0), allowing the liquid membrane to become compressible, to reduce the effect of any pumping action that would otherwise occur in the gap. To state it in another manner, it is believed that the cavitation air bubble isolates the continuous liquid membrane. Since the pressure within the cavitation air bubble is negative, it should normally be eliminated in a short time period. While there are air bubbles that float within the liquid, these remaining air bubbles should be eliminated when contacting residual air, and there should be no occurrences of air bubbles flowing into the load side. Also, even if there is contact between the seal surface of the rotating body and the oscillator surface that is vibrating at a high frequency, friction between the two surfaces should be extremely small. Although the direction of oscillation of the end portion surface of the oscillating body is perpendicular to the interaction disc of the rotor, which is rotating, if the contact pressure is adjusted by manipulating, inter alia, the oscillator amplitude, there should be relatively little rubbing, and thus, little in the way of power loss, friction, wear and heat generation, which represents a demonstrable advantage over known dynamic shaft seals.

Although as indicated above, in the present invention, wear in the seal surface is minimal, cavitation may cause surface roughness. If some roughness occurs, the gaps resulting from roughness can be filled in by cavitation air bubbles. Also, as the oscillator surface can be plated with metal, or covered in a resin, and the interaction disc has a vulcanized rubber layer affixed to its surface, making it elastic, they are not easily damaged by cavitation. Of course, the parts are replaceable in the event of damage.

While but a single embodiment of the present invention has been herein shown and described, as has but a single test use, it will be understood that various changes may be made. Firstly, it should be understood that, whereas the support plate is shown herein as a separate plate, the structure through which the aperture is defined could advantageously form part of a pump or turbine housing, such that mechanical shaft power can be transmitted into or from said housing without leakage. As well, whereas main tube (1) is shown as cylindrical, other shapes could be employed. Further, whereas ferrite is specified as the magnetostrictive material of which the oscillating body is constructed, other magnetostrictive materials could be utilized. Additionally, whereas four magnetostrictive oscillators are shown, greater or lesser numbers could be employed. Moreover, whereas the rotor is described herein as a separate, threaded component, it could be formed integrally with the shaft. Variations in amplitude and frequency are also contemplated. For example, the seal member may oscillate at frequencies lower than 10 khz. From the above, it should be understood that the scope of the invention is to be limited only by the claims appended hereto, purposively construed.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

1. A shaft seal for use with a rotating shaft and a structure defining an aperture through which the shaft extends, said shaft seal comprising:
a rotor, said rotor, in use, being sealingly secured to said shaft, on one side of said aperture, for rotation therewith;
a seal member, said seal member, in use, defining a void through which said shaft extends in spaced relation, being operatively sealed about said aperture and manipulable between a first position, abutting the rotor to seal the aperture, and a second position, spaced from the rotor,
a driver adapted to oscillate the seal member between the first position and the second position, at a frequency such that, in use, liquid disposed on said one side of said aperture cannot infiltrate said void for egress to said aperture.

2. A shaft seal according to claim 1, wherein the frequency is ≧10 kHz.

3. A shaft seal according to claim 1, wherein the distance between the first position and the second position is less than 1/100 mm.

4. A shaft seal according to claim 1, wherein the seal member and driver together define one or more magnetostrictive oscillators.

5. A shaft seal according to claim 4, wherein each of said one or more magnetostrictive oscillators includes a magnetostrictive portion, a coil surrounding the magnetostrictive portion and an end portion connected to the magnetostrictive portion, the end portions being connected together to form said seal member.

6. A shaft seal according to claim 5, wherein the seal member defines a circular planar surface orientated normal to and surrounding said shaft and in which said void is defined.

7. A shaft seal according to claim 5, further comprising a cylinder within which are at least partially positioned said magnetostrictive portions, said cylinder being closed at one end by said seal member, to form in combination with said seal member and said magnetostrictive portions, a unitary oscillating body having an amplitude of vibration and a node thereof.

8. A shaft seal according to claim 7, further comprising an annular support leg inserted, at the node, between the cylinder and the magnetostrictive portions, to join same together.

9. A shaft seal according to claim 8, wherein the seal member is sealed to the structure by a ring inserted, at the node, between the cylinder and the structure.

10. A shaft seal according to claim 9, wherein the seal member is sealed to the structure by a tube sealed to each of the ring and the structure and in which is positioned the rotor and the seal member.

11. A shaft seal according to claim 1, wherein the rotor is threaded to the shaft in use.

12. A shaft seal according to claim 1, wherein the rotor comprises:
a seal disc defining an annular hollow presenting towards the seal member; and
an annular interaction disc disposed within said hollow, said disc having an interior rim creating a gap between the seal disc and the interaction disc,
one or more flexible rods rigidly extending from the interaction disc and secured to the seal disc to provide a non-rigid connection therebetween.

13. A shaft seal according to claim 12, wherein the seal disc defines passages to permit liquid on said one side of the aperture to circulate through the gap to cool the interaction disc in use.

14. A shaft seal according to claim 12, further comprising an annular layer of elastic material secured to the interaction disc and presenting towards the seal member.

15. A shaft seal according to claim 14, wherein the elastic material is vulcanized rubber.

16. A shaft seal according to claim 12, wherein each of said one or more rods is threaded and extends through the seal disc to a free end, and further comprising a nut threaded onto the end of said rod and a spring captured between said nut and said main body portion, whereby the play of said non-rigid connection can be adjusted by manipulating said nut.

17. A shaft seal according to claim 10, wherein the cylinder, magnetostrictive portions, end portions and support leg are constructed of ferrite.

18. A shaft seal according to claim 10, wherein the magnetostrictive portions are stabilized by sponge rubber pads inserted between said magnetostrictive portions and said structure.

19. A shaft seal according to claim 7, wherein the rotor includes an annular flange surrounding said one end of the cylinder.

20. A shaft seal for use with a rotating shaft and a structure defining an aperture through which the shaft extends, said shaft seal comprising:
a rotor, said rotor, in use, being sealingly secured to said shaft for rotation therewith;
an oscillating body, said oscillating body, in use, being disposed between said rotor and said aperture, defining a void through which said shaft extends in spaced relation, being operatively sealed about said aperture and including a magnetostrictive portion deformable such that the oscillating body is configurable in a first configuration, abutting the rotor to seal the aperture, and a second configuration, spaced from the rotor; and
a coil surrounding the magnetostrictive portion and adapted to cause oscillatory deformation of the oscillating body to cause same to oscillate between the first configuration and the second configuration.
